(19) United States
(12) Patent Application Publication
(10) Pub. No.: US 2015/0237927 A1
(43) Pub. Date: Aug. 27, 2015

(54) Temperature Controlled Personal Environment

(71) Applicants: Jan Nelson, Wauna, WA (US); Reid Nelson, Seattle, WA (US)

(72) Inventors: Jan Nelson, Wauna, WA (US); Reid Nelson, Seattle, WA (US)

(21) Appl. No.: 14/596,491

(22) Filed: Jan. 14, 2015

Related U.S. Application Data
(60) Provisional application No. 61/943,345, filed on Feb. 22, 2014.

(51) Int. Cl. A41D 13/005; A47C 7/40; H05B 1/02; A47C 21/04; F25B 21/04; A47G 9/02; A47G 9/08

(52) U.S. Cl. CPC A41D 13/0051; A47G 9/0215; A47C 7/40; A47G 9/08; A47C 21/044; A47C 21/048; A41D 13/0053; F25B 21/04; H05B 1/0275

(57) ABSTRACT

An automatically temperature controlled personal environment for a person, comprising a body envelopment for receiving the body of a user, a plurality of temperature sensors, a data processor for storing temperature control parameters, a wireless remote user interface and a local user interface, for entering the temperature control parameters into the data processor, heating and cooling apparatus for heating and cooling the body envelopment, a source of power for operating the heating and cooling apparatus, and a heating and cooling apparatus controller which activates the heating and cooling apparatus when the sensor senses temperatures outside stored temperature control parameters. The body envelopment may be a body suit, a chair, a blanket, or a sleeping bag.

### CROSS-REFERENCE TO RELATED APPLICATION

This application is a Non-Provision Utility application and claims the benefit of the filing date of U.S. Provisional Application Ser. No. 61/943,345 filed on Feb. 22, 2014, the contents of which are incorporated herein by reference.

### FIELD OF THE DISCLOSURE

The present disclosure relates to temperature controlled personal environments, such as heated and cooled body suits.

### BACKGROUND

People must from time to time work or live under ambient conditions which are excessively hot or cold for comfort. Accordingly, systems have been proposed for enclosing a person within a personal environment which is temperature controlled. Illustratively, close fitting body suits, sleeping bags, blankets, chairs and seats, and other devices have been provided with heating and cooling apparatus.

Suitable control over temperature in personal environments remains problematic. Controls can be provided to adjust temperatures. However, temperature requirements may change over time, requiring annoying or difficult adjustment of heating and cooling outputs. There remains a need in the field of personal environments to provide automatic, adjustable heating and cooling control.

### SUMMARY

The present disclosure addresses the above stated situation by providing a personal environment having heating and cooling systems which are automatic and adjustable. The controls may be digitized and remotely set or programmed. Sensors determine local temperature conditions, with automatic adjustment being effected if the sensed temperatures are outside an acceptable range of predetermined or preset temperatures.

It is an object to provide improved elements and arrangements thereof by apparatus for the purposes described which is inexpensive, dependable, and fully effective in accomplishing its intended purposes.

These and other objects will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a generic, schematic representation of a temperature controlled personal environment, according to at least one aspect of the disclosure;

FIG. 1A is a schematic detail view showing one alternative of a component seen at the center right of FIG. 1;

FIG. 1B is a schematic detail view showing another alternative of the component seen at the center right of FIG. 1;

FIG. 2 is a front view of a specific form of the temperature controlled personal environment of FIG. 1, showing a representative layout of heating and cooling elements, according to at least another aspect of the disclosure;

FIG. 3 is a front view of the temperature controlled personal environment of FIG. 2, but shows a representative layout of temperature sensors, according to at least one further aspect of the disclosure;

FIG. 4 is a top plan view of another specific form of the temperature controlled personal environment of FIG. 1, according to still another aspect of the disclosure;

FIG. 5 is a side view of still another form of the temperature controlled personal environment of FIG. 1, according to yet another aspect of the disclosure; and

FIG. 6 is a perspective view of still a further form of the temperature controlled personal environment of FIG. 1, according to a still further aspect of the disclosure.

### DETAILED DESCRIPTION

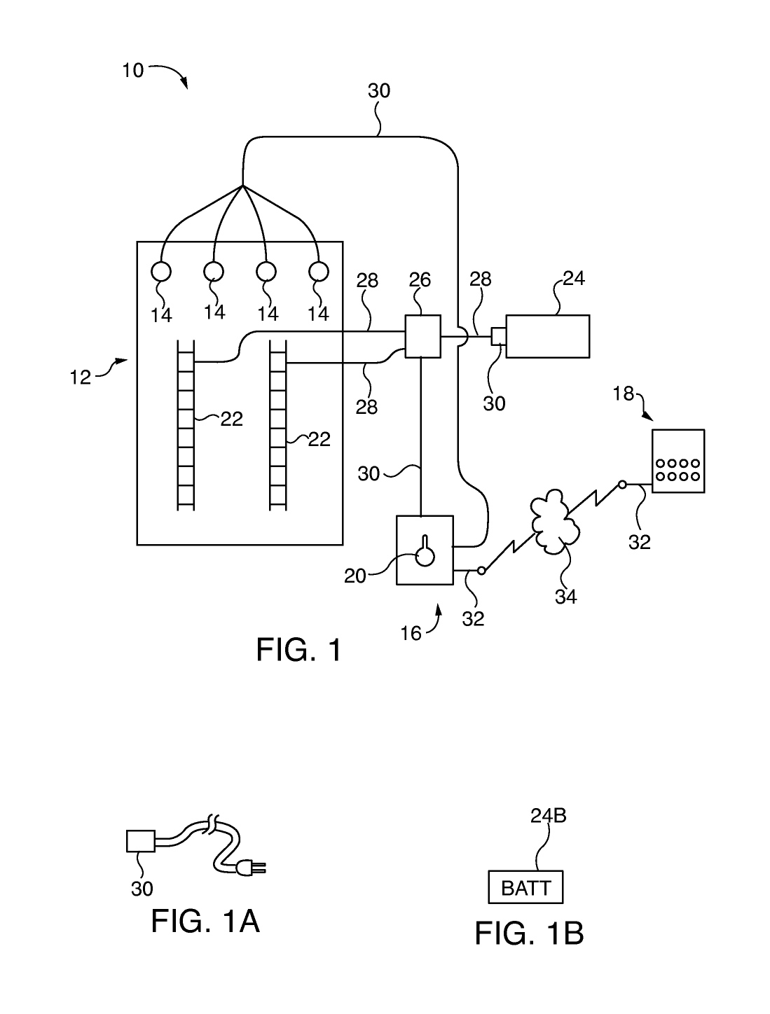

Referring first to FIG. 1, according to at least one aspect of the disclosure, there is shown an automatically temperature controlled personal environment 10 for a person (not shown). The automatically temperature controlled personal environment 10 comprises a body envelopment 12 for receiving the body of a user (not shown), at least one sensor 14 for sensing local temperature at a predetermined location within the body envelopment 12, a data processor 16 for storing temperature control parameters, a remote user interface 18 for entering the temperature control parameters into data processor 16, a local user interface 20 for entering the temperature control parameters into data processor 16, heating and cooling apparatus 22 for heating and cooling body envelopment 12, a source of power 24 for operating heating and cooling apparatus 22, and a heating and cooling apparatus controller 26 which activates heating and cooling apparatus 22 when sensor(s) 14 sense temperatures outside stored temperature control parameters.

Automatically temperature controlled personal environment 10 will be understood to include electrical power conductors 28 to distribute operating power from source of power 24 to heating and cooling apparatus 22, and data signal conductors 30 to conduct data signals indicative of sensed temperatures from sensors 14 to data processor 16. Data processor 16 will be understood to include memory and processing apparatus and necessary firmware or software for operability. Source of power 24 will be understood to include a power converter 30 and optionally, a voltage transformer which converts AC power to DC power, the latter where source of power 24 connects to AC power. For example, source of power 24 may comprise a cord and plug assembly 24A (FIG. 1A). Source of power 24 may also comprise a battery 24B (FIG. 1B), in which case the power converter 30 (optionally including the voltage transformer) may be located between battery 24B and a source of AC or DC power.

Sensors 14 may be thermostatic in nature. Alternatively, any or all of sensors 14 may include one or more sensors of galvanic skin response, and one or more heart rate sensor. The combination of at least one galvanic skin response and at least heart rate sensor may be used to infer body temperature. The galvanic skin response sensor(s) and heart rate sensor(s), which may be called biometric sensors, may provide more useful information or provide for faster temperature adjustment when determining whether to activate heating and cooling. For example, the body may exhibit responses to perceived high or low temperatures before actual temperatures sensed by a thermostatic sensor would provoke heating or cooling. The body may respond to perceived high temperatures by sweating, or to perceived low temperatures by reducing blood flow to body extremities. Response time to galvanic skin response and heart rate may reflect in real time the point at which discomfort is experienced. In that respect, biometric sensors 14 may be regarded as proactive, compared to conventional thermostatic sensors 14.

Use of the term “body envelopment” is not intended to imply full envelopment of the body of the user. Rather, this term is used to signify that part of an automatically temperature controlled personal environment 10 which contacts the body of the user in ordinary use.

Local user interface 20 may will be understood to include control circuitry for controlling each heating and cooling apparatus 22 individually, both as to increasing the amount of heating or cooling, and also to switch from heating to cooling (or the reverse). The control circuitry of local user interface 20 is arranged to override temperature control parameters entered into data processor 16 from remote user interface 18.

Remote user interface 18 is programmable to set each heating and cooling apparatus 22 individually. Remote user interface 18 communicates wirelessly with data processor 16. Both remote user interface 18 and data processor 16 will be understood to include necessary circuitry and apparatus to accomplish this communication, such as antennae 32. Wireless communications capability of remote user interface 18 and data processor 16 may include an internet link 34.

Heating and cooling apparatus 22 may comprise at least one thermoelectric heating and cooling, or peltier effect, element. Heating and cooling functions in thermoelectric devices is effected by reversing polarity of electrical input power polarity. Heating and cooling apparatus controller 26 will be understood to include an internal switch (not separately shown) to enable reversal of power polarity. Although illustrated only in schematic form rather than literally, it should be understood that one heated or cooled element of any one heating and cooling apparatus 22 of the thermoelectric type will be internal to body envelopment 12, with the corresponding heated or cooled element being exposed at the surface of body envelopment 12, to allow for operable heat distribution.

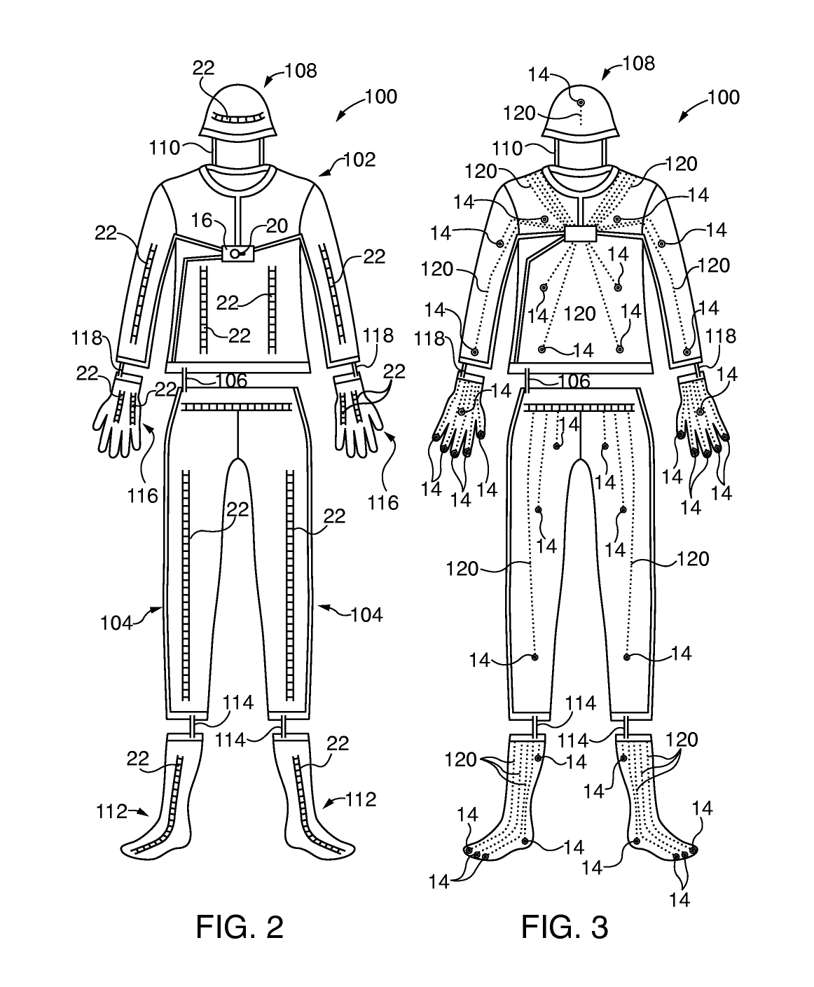

Automatically temperature controlled personal environment 10 has been presented in generic form in FIGS. 1, 1A, and 1B. Referring now to FIGS. 2 and 3, body envelopment 12 comprises a body suit 100 including a torso covering member 102 heated and cooled by heating and cooling apparatus 22 and two leg covering members 104 heated and cooled by heating and cooling apparatus 22. Leg covering members 104 are connected to torso covering member 102 by a ribbon cable 106. Ribbon cable 106 is a relatively flat assembly of power and sensor signal conductors and insulation. Body suit 100 further comprises a head covering member 108 heated and cooled by heating and cooling apparatus 22. Head covering member 108 is connected to body suit 100 only by a ribbon cable 110. Body suit 100 further comprises two foot covering members 112 heated and cooled by heating and cooling apparatus 22. Foot covering members 112 are connected to body suit 100 only by respective ribbon cables 114. Body suit 100 further comprises two hand covering members 116 heated and cooled by heating and cooling apparatus 22. Hand covering members 116 are connected to body suit 100 only by respective ribbon cables 118.

Ribbon cables 110, 114, 118 may all have structural characteristics of ribbon cable 106, differing only in location on body suit 100 and in overall length. Ribbon cables 106, 110, 114, 118 may be continuous between supply conductors 28 (see FIG. 1) and those heating and cooling apparatuses 22 to which ribbon cables 106, 110, 114, 118 are connected. As an alternative, where it is desired to be able to fully separate any one body covering member (such as torso covering member 102, leg covering members 104, head covering member 108, and foot covering members 112) from another body covering member, ribbon cables 106, 110, 114, 118 may be provided with manually joined and separated plug-in connectors (not shown).

Body suit 100 is shown only in representative capacity. A body suit according to the present disclosure may be varied from that depicted in the drawings. For example, legs, arms, and other portions of a body suit may be modified to suit the purposes of a particular endeavor. Examples of activities using a body suit according to the present disclosure include skiing, swimming, diving, working in unheated environments, using snowmobiles and motorcycles, and still others where exposure to extremes of temperature is encountered.

FIG. 3 shows an exemplary array of sensors 14. Each sensor 14 is individually connected to data processor 16 by dedicated signal conductors 120, so that localized temperature conditions throughout body suit 110 may be monitored. For clarity of the view, not all signal conductors 120 are called out by reference numeral. Similarly, not all ribbon cables are called out by reference numeral.

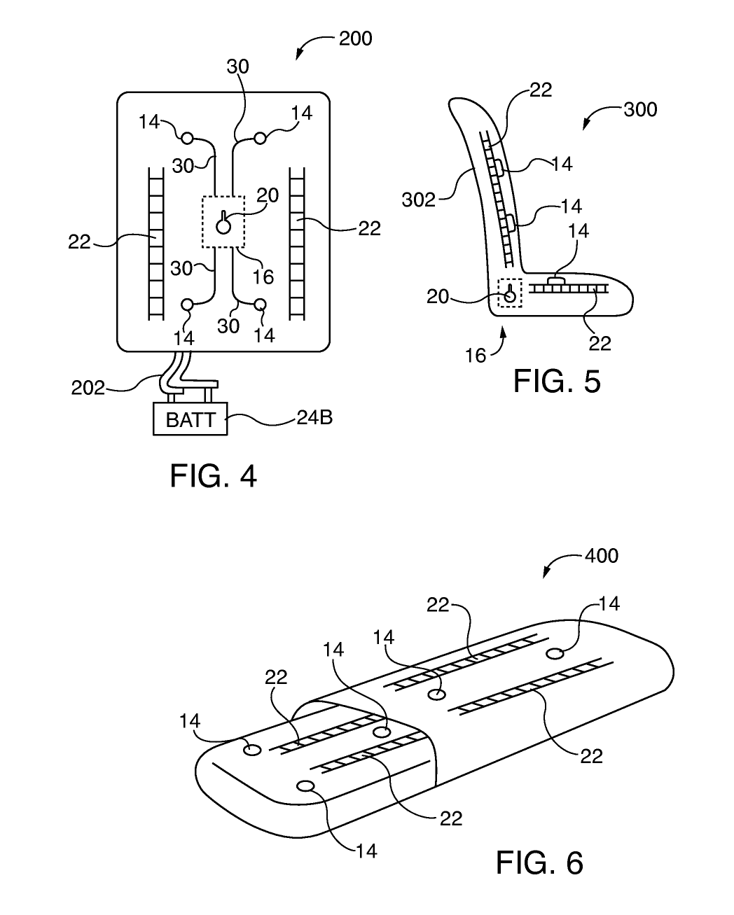

Turning now to FIG. 4, there is shown an implementation of automatically temperature controlled personal environment 10, wherein body envelopment 12 is a blanket 200. Battery 24B is shown separate from blanket 202, and is connected by a cable 202. It would be possible to contain battery 24B within blanket 200.

Referring to FIG. 5, in another implementation of automatically temperature controlled personal environment 10, body envelopment 12 is a seat 300 including a backrest 302.

Referring to FIG. 6, in another implementation of automatically temperature controlled personal environment 10, body envelopment 12 is a sleeping bag 400.

In the implementations of FIGS. 4, 5, and 6, some details have been omitted for clarity of the view. It will be appreciated that blanket 200, chair 300, and sleeping bag 400 include of the types of components initially introduced and explained with reference to FIG. 1, although the number, dimensions, and configurations of such components will vary according to dimensions and configurations of the various implementations.

The principles of this disclosure, which have been set forth explicitly for body suit 100, blanket 200, chair 300, and sleeping bag 400, may be applied to still other types of personal environments. These may include dry and wet diving suits, protective gear such as firemen's suits, uniforms, and still others (none shown).

Types of heating and cooling apparatus 22 other than thermoelectric devices may be incorporated into an automatically temperature controlled personal environment 10, according to further aspects of the disclosure. For example, a heating and cooling apparatus 22 may include heat exchangers and supply and return conduits, and a supply of heated or cooled fluid (this option is not shown). The supply or return conduits, or both, may be provided with modulating valves to vary the supply of heat carrying fluid. Different types of heating and cooling apparatus 22 may be combined in any one temperature controlled personal environment 10, if desired.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

It should be understood that the various examples of the apparatus(es) disclosed herein may include any of the components, features, and functionalities of any of the other examples of the apparatus(es) disclosed herein in any feasible combination, and all of such possibilities are intended to be within the spirit and scope of the present disclosure. Many modifications of examples set forth herein will come to mind to one skilled in the art to which the present disclosure pertains having the benefit of the teachings presented in the foregoing descriptions and the associated drawings.

Therefore, it is to be understood that the present disclosure is not to be limited to the specific examples presented and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims.

What is claimed is:

1. An automatically temperature controlled personal environment for a person, comprising:
a body envelopment for receiving the body of a user;
at least one sensor for sensing local temperature at a predetermined location within the body envelopment;
a data processor for storing temperature control parameters;
a remote user interface for entering the temperature control parameters into the data processor;
a local user interface for entering the temperature control parameters into the data processor;
heating and cooling apparatus for heating and cooling the body envelopment, and a source of power for operating the heating and cooling apparatus; and
a heating and cooling apparatus controller which activates the heating and cooling apparatus when the sensor senses temperatures outside stored temperature control parameters.

2. The automatically temperature controlled personal environment of claim 1, wherein the body envelopment comprises a body suit including a torso covering member heated and cooled by the heating and cooling apparatus and two leg covering members heated and cooled by the heating and cooling apparatus.

3. The automatically temperature controlled personal environment of claim 2, wherein the two leg covering members are connected to the torso covering member by a ribbon cable.

4. The automatically temperature controlled personal environment of claim 2, wherein the body suit further comprises a head covering member heated and cooled by the heating and cooling apparatus.

5. The automatically temperature controlled personal environment of claim 4, wherein the head covering member is connected to the body suit only by a ribbon cable.

6. The automatically temperature controlled personal environment of claim 2, wherein the body suit further comprises two foot covering members heated and cooled by the heating and cooling apparatus.

7. The automatically temperature controlled personal environment of claim 6, wherein the two foot covering members are connected to the body suit only by respective ribbon cables.

8. The automatically temperature controlled personal environment of claim 2, wherein the body suit further comprises two hand covering members heated and cooled by the heating and cooling apparatus.

9. The automatically temperature controlled personal environment of claim 8, wherein the two hand covering members are connected to the body suit only by respective ribbon cables.

10. The automatically temperature controlled personal environment of claim 1, wherein the heating and cooling apparatus comprises at least one thermoelectric heating and cooling element.

11. The automatically temperature controlled personal environment of claim 1, wherein the local user interface overrides temperature control parameters entered into the data processor from the remote user interface.

12. The automatically temperature controlled personal environment of claim 1, wherein the remote user interface communicates wirelessly with the data processor.

13. The automatically temperature controlled personal environment of claim 12, wherein wireless communication between the remote user interface and the data processor includes an internet link.

14. The automatically temperature controlled personal environment of claim 1, wherein the body envelopment is a blanket.

15. The automatically temperature controlled personal environment of claim 1, wherein the body envelopment is a seat including a backrest.

16. The automatically temperature controlled personal environment of claim 1, wherein the body envelopment is a sleeping bag.

17. The automatically temperature controlled personal environment of claim 1, wherein the power source comprises a battery.

18. The automatically temperature controlled personal environment of claim 1, wherein the power source comprises a plug and cord assembly, and a current converter which converts AC power to DC power.

19. The automatically temperature controlled personal environment of claim 1, wherein the sensor is thermostatic.

20. The automatically temperature controlled personal environment of claim 1, wherein the sensor is biometric.

21. The automatically temperature controlled personal environment of claim 20, wherein the sensor includes a galvanic skin response sensor and a heart rate sensor.
